(19) United States
(12) Patent Application Publication
(10) Pub. No.: US 2014/0368654 A1
(43) Pub. Date: Dec. 18, 2014

(54) CHROMATIC ABERRATION COMPENSATION FOR VEHICLE CAMERAS

(71) Applicant: MAGNA ELECTRONICS INC., Auburn Hills, MI (US)

(72) Inventor: Thomas Wierich, Butzbach (DE)

(21) Appl. No.: 14/303,693

(22) Filed: Jun. 13, 2014

Related U.S. Application Data
(60) Provisional application No. 61/836,380, filed on Jun. 18, 2013.

(51) Int. Cl. H04N 7/18; B60R 1/12

(52) U.S. Cl. CPC H04N 7/183; B60R 1/12; B60R 2001/1253
USPC 348/148

(57) ABSTRACT

A vision system of a vehicle includes a camera disposed at a vehicle and having a field of view exterior of the vehicle. The camera includes a lens and a pixelated imaging array having a plurality of photosensing elements. The camera is operable to sense color via color filters at respective photosensing elements. An image processor is operable to process image data captured by the camera. The vision system is operable to determine an aberration of colors in the captured image data and to correct the aberration of colors. The vision system determines the aberration based on parameters of the lens, and the vision system may corrects the aberration of colors by scaling the color channels according to a location of the respective pixels and the respective parameters of the lens for that location.

### CROSS REFERENCE TO RELATED APPLICATION

The present application claims the filing benefits of U.S. provisional application Ser. No. 61/836,380, filed Jun. 18, 2013, which is hereby incorporated herein by reference in its entirety.

### FIELD OF THE INVENTION

The present invention relates generally to a vehicle vision system for a vehicle and, more particularly, to a vehicle vision system that utilizes one or more cameras at a vehicle.

### BACKGROUND OF THE INVENTION

Use of imaging sensors in vehicle imaging systems is common and known. Examples of such known systems are described in U.S. Pat. Nos. 5,949,331; 5,670,935; and/or 5,550,677, which are hereby incorporated herein by reference in their entireties.

### SUMMARY OF THE INVENTION

The present invention provides a collision avoidance system or vision system or imaging system for a vehicle that utilizes one or more cameras (preferably one or more CMOS cameras) to capture image data representative of images exterior of the vehicle, and provides a vision system of a vehicle that is operable to correct color aberration in captured images to provide an enhanced display of the captured images for viewing by a driver of the vehicle.

For example, the camera may comprise a lens and a pixelated imaging array having a plurality of photosensing elements, with the camera operable to sense color via color filters at respective photosensing elements. An image processor or image processing system is operable to process image data captured by the camera. The image processor is operable to determine an aberration of colors in the captured images and to correct the aberration of colors. The image processor determines the aberration based on parameters of the lens, and the image processor may at least in part correct the aberration of colors by scaling each of the color channels of the camera according to a location of the respective pixels and the respective parameters of the lens for that location. The image processor may determine a displacement distance of the light's color components that is determined responsive to the parameters of the lens and the location of the pixels relative to the lens, and the image processor adjusts captured image data in accordance with the determined displacement distance to correct the aberration of colors.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a vision system that incorporates cameras in accordance with the present invention;

FIG. 2 is a schematic showing the chromatic aberration of a lens with low or no means for reducing lateral chromatic aberration, where the effect is stronger the more distant (r) the image passes the lens off the center, and where red colors become aberrated more than green and blue colors;

FIG. 3 is a schematic showing the desired line projection when the chromatic aberration is fully compensated by any means (optically or electronically), where no color splicing applies (a white source appears as white);

FIG. 4 is a schematic showing an aberration d1 at radius r1 that is different (less) than an aberration d2 on distance to the center r2 of the green color light component;

FIG. 5 is a schematic showing an aberration d1 at radius r1 that is different (less) than an aberration d2 on distance to the center r2 of the red color light component, wherein, when comparing to FIG. 4, the d1-green is smaller than d1-red and d2-green is smaller than d2-red;

Chart 1 shows the quantum efficiency over wavelengths of an Aptina AR0132AT CMOS sensor; and

Chart 2 shows a curve of chromatic aberration compensation ratio over wavelengths in accordance with the present invention.

### DESCRIPTION OF THE PREFERRED EMBODIMENTS

A vehicle vision system and/or driver assist system and/or object detection system and/or alert system operates to capture images exterior of the vehicle and may process the captured image data to display images and to detect objects at or near the vehicle and in the predicted path of the vehicle, such as to assist a driver of the vehicle in maneuvering the vehicle in a rearward direction. The vision system includes an image processor or image processing system that is operable to receive image data from one or more cameras and provide an output to a display device for displaying images representative of the captured image data. Optionally, the vision system may provide a top down or bird's eye or surround view display and may provide a displayed image that is representative of the subject vehicle, and optionally with the displayed image being customized to at least partially correspond to the actual subject vehicle.

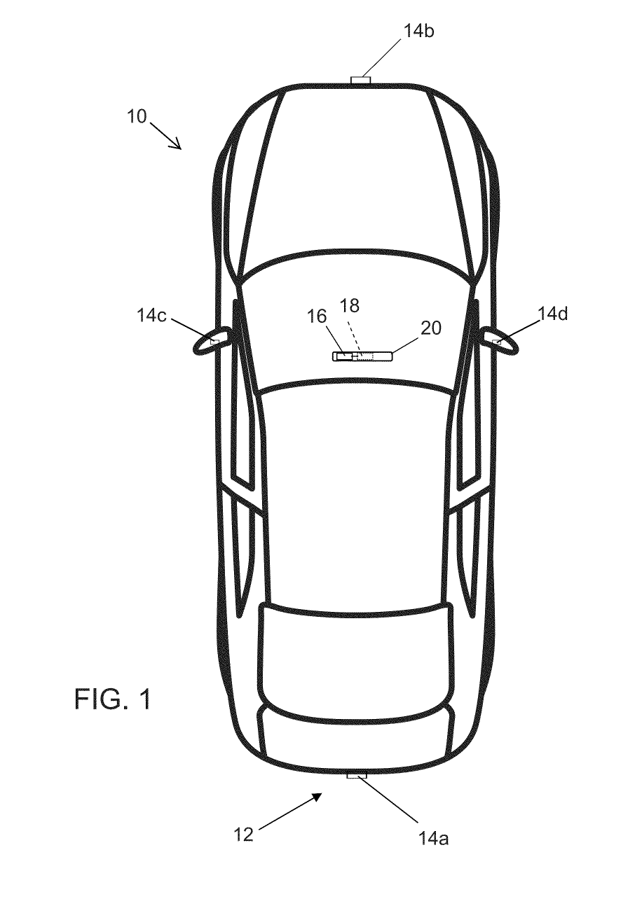

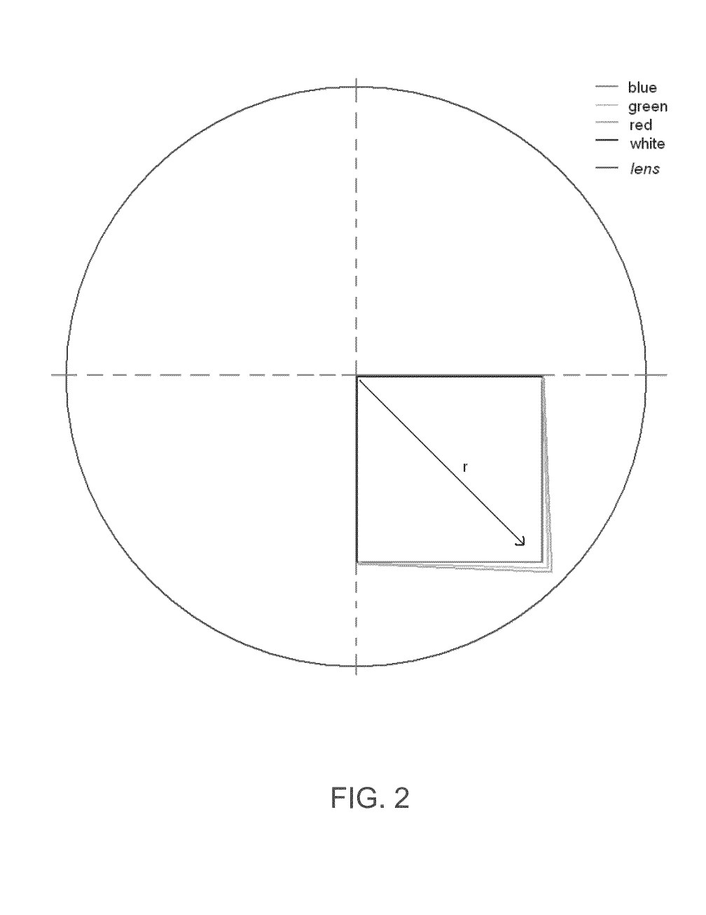

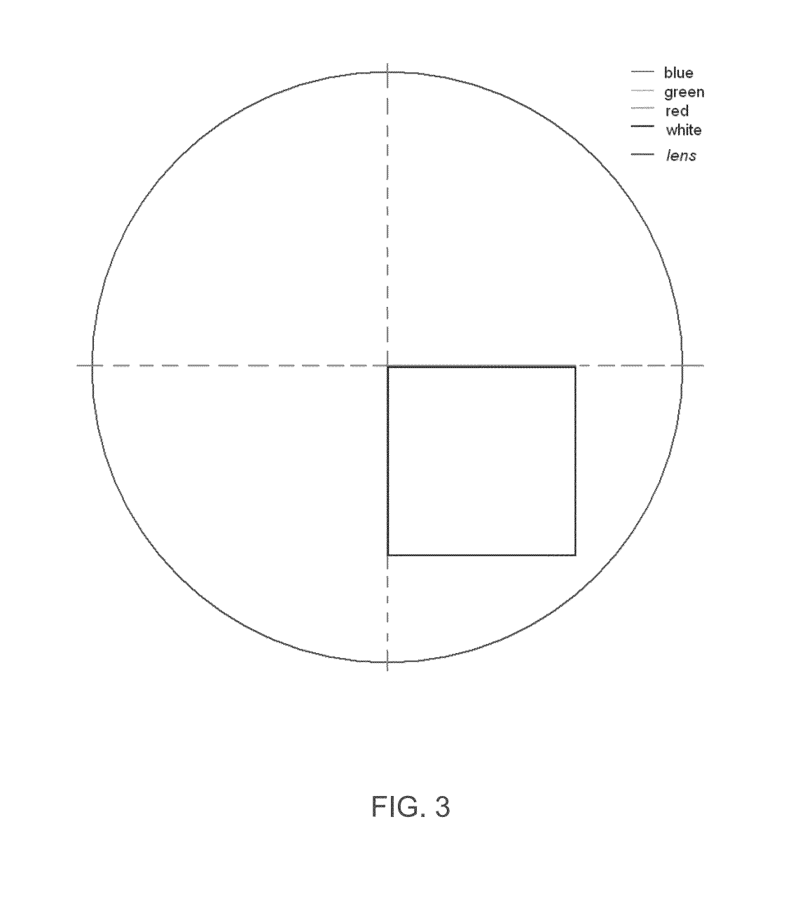

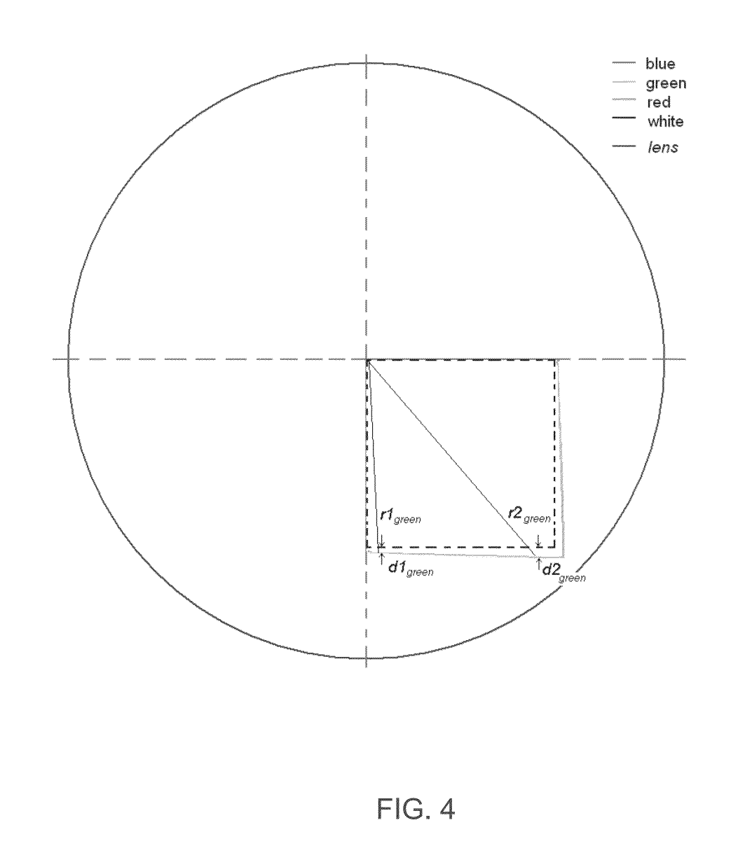

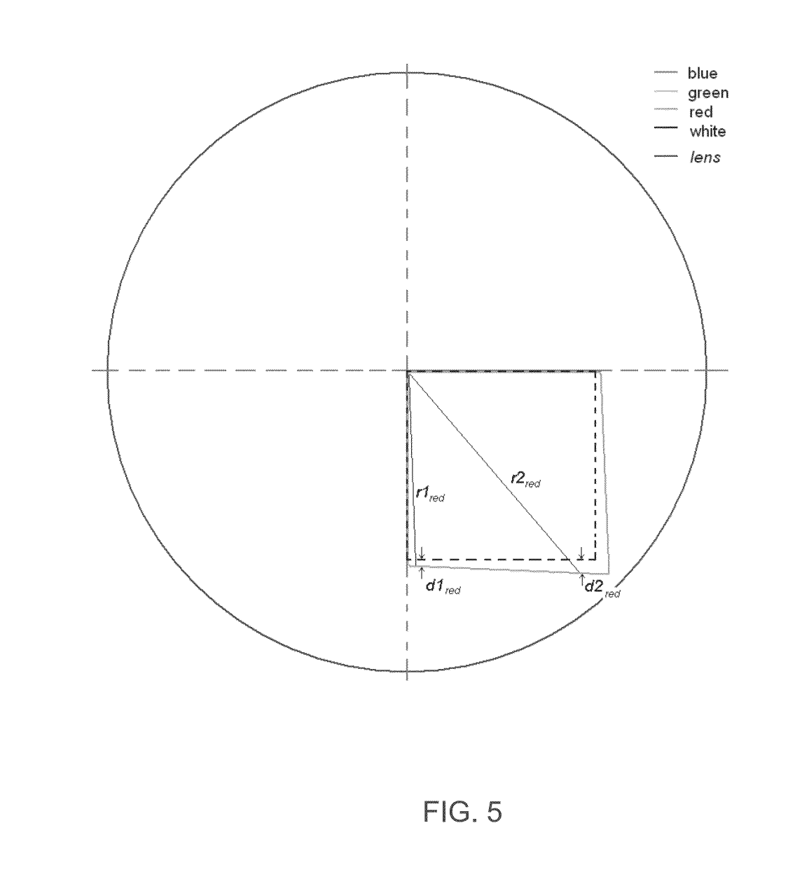

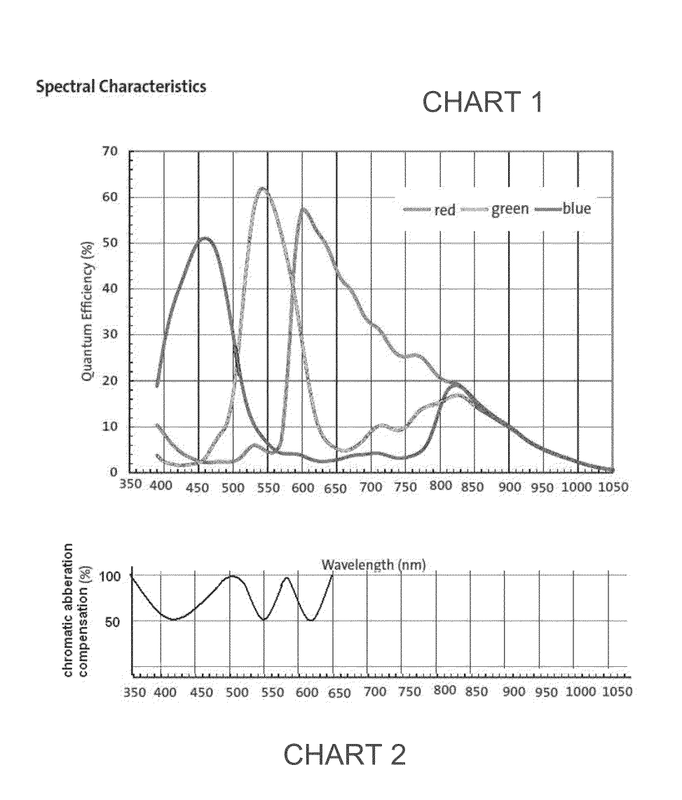

Referring now to the drawings and the illustrative embodiments depicted therein, a vehicle 10 includes an imaging system or vision system 12 that includes at least one exterior facing imaging sensor or camera, such as a rearward facing imaging sensor or camera 14a (and the system may optionally include multiple exterior facing imaging sensors or cameras, such as a forwardly facing camera 14b at the front (or at the windshield) of the vehicle, and a sidewardly/rearwardly facing camera 14c, 14d at respective sides of the vehicle), which captures images exterior of the vehicle, with the camera having a lens for focusing images at or onto an imaging array or imaging plane or imager of the camera (FIG. 1). The vision system 12 includes a control or electronic control unit (ECU) or processor 18 that is operable to process image data captured by the cameras and may provide displayed images at a display device 16 for viewing by the driver of the vehicle (although shown in FIG. 1 as being part of or incorporated in or at an interior rearview mirror assembly 20 of the vehicle, the control and/or the display device may be disposed elsewhere at or in the vehicle). The data transfer or signal communication from the camera to the ECU may comprise any suitable data or communication link, such as a vehicle network bus or the like of the equipped vehicle. The cameras may be part of a multi-camera surround vision system of the vehicle, with the plurality of cameras being disposed at respective portions of the vehicle and having respective fields of view exterior the vehicle.

Transversal/lateral chromatic aberration appears on optical media thresholds (such as, for example, glass to air) when passing light is broken or refracted on it. Because the breaking angles or refracting angles (due to the media threshold) of different light wave lengths, different colors become spread out or separated. Due to the geometrical nature of light collecting lens systems, the light passes the first lens in a stronger angle at the side of the lens as compared to at the center of the lens (assuming a common round shape lens system). Because of this, the transversal/lateral chromatic aberration is increasingly stronger at or near the sides of the lens (in common radius). To cope with this, the transversal/lateral chromatic aberration or the spread of colors in the light is preferably redirected to the identical target position (the film or imager). This is typically a cost driving quality item of lens systems. Lens systems with such properties are called achromatic when partially correcting and apochromatic when fully correcting.

Typically, lens systems of automotive vision cameras comprise numerous lens elements (such as, for example, typically between five and eight optic elements). Some lens elements incorporate aberration correction and some are especially dedicated to cope with the transversal/lateral chromatic aberration. Often, lenses are set up in duplets and triplets to design an achromat or apochromat. Handheld cameras with built in chromatic aberration correction are known. Also, post shot or post image capture PC algorithms are known for chromatic aberration correction (such as, for example, Adobe Photoshop or the like).

Instead of investing in optical compensation of the transversal/lateral chromatic aberration (such as use of the likes of duplets and triplets), comparable primitive and cheaper lens system may come into use that may comprise just single lenses or lens elements or optic elements (instead of triplets and duplets) in combination with an algorithm that is operable to cope with the consequences of transversal/lateral chromatic aberration of the lens system electronically, such as by an image processing algorithm incorporated in the image processing pipeline.

The lens system may comprise a reduced number of lenses or lens elements and/or may comprise less good or less complicated or less expensive lens materials and surface materials and application processes to reduce costs and space requirements for the lens.

Because the transversal/lateral chromatic aberration is causing a displacement of the light's color components of the same illuminating or reflecting objects in front of the camera on the image sensor, and because this aberration's parameters are known by the knowledge of the (common) lens system, the displacement's distance (or amount of aberration) on the sensor of every color component is known (in case there are no optical means to cope with the aberration, the aberration is depending on or may be a function of the radius off center for respective regions). Because the image sensor (typically) filters on the three main colors, such as green, red and blue (seldom also near and/or far infrared), which are naturally distant in wavelengths, the algorithm has to correct the aberration or displacement of each of these colors.

Because there is no serious unsharping or blurring caused by the transversal/lateral chromatic aberration, the task (to the algorithm) is just a scaling correction of each of the single color (wavelengths) channels to achieve a matching of all color channels. Algorithms known from the handheld cameras (such as similar to that of a Nikon D90 camera or the like) may work this way. The corrections have to be adjusted according to the lens properties of the lenses of the particular vehicle applications.

Typically, automotive vision system camera images may be scaled within the image pipeline anyway. In order to avoid the images becoming scaled for transversal/lateral chromatic aberration reduction and for size scaling (so two times), both scaling operations may be combined in one step as another optional aspect of the present invention.

Natural scene images comprise a full band of all visible colors. Of course also these include pure green, red and blue. However, pixel cameras and displays conceive or sense or recognize just these colors. Colors in between these colors are conceived or sensed or recognized in divided ratios for pixels of wavelength in their neighborhood (see Chart 1). The aberration of the “in between” or “aside” colors cannot be fully compensated by the correction algorithm since their displacement is at least minimal different to the pixel's main color. These minor remaining aberrations may be acceptable.

If such minor aberration is not acceptable, and as an alternative aspect of the present invention, a lens system may be used that is optimally designed in terms of transversal/lateral chromatic aberration at wavelengths off (or between) the imager pixel conception maximums and less optimally designed at the imager pixel conception maximums (such as like shown in Chart 2). When using the above specified correction algorithm, which works optimally at the imager pixel conception maximum wavelengths, this may result in optimized (common) results in terms of image quality and according costs. The lens system may be cheaper when not being designed optimally over the whole visible wavelengths but just at some (“in between” or “side”) wavelengths.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in International Publication Nos. WO 2013/081984 and/or WO 2013/081985, which are hereby incorporated herein by reference in their entireties.

The system includes an image processor operable to process image data captured by the camera or cameras, such as for detecting objects or other vehicles or pedestrians or the like in the field of view of one or more of the cameras. For example, the image processor may comprise an EyeQ2 or EyeQ3 image processing chip available from Mobileye Vision Technologies Ltd. of Jerusalem, Israel, and may include object detection software (such as the types described in U.S. Pat. Nos. 7,855,755; 7,720,580; and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ladar sensors or ultrasonic sensors or the like. The imaging sensor or camera may capture image data for image processing and may comprise any suitable camera or sensing device, such as, for example, a two dimensional array of a plurality of photosensor elements arranged in at least 640 columns and 480 rows (at least a 640×480 imaging array, such as a megapixel imaging array or the like), with a respective lens focusing images onto respective portions of the array. The photosensor array may comprise a plurality of photosensor elements arranged in a photosensor array having rows and columns. Preferably, the imaging array has at least 300,000 photosensor elements or pixels, more preferably at least 500,000 photosensor elements or pixels and more preferably at least 1 million photosensor elements or pixels. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

For example, the vision system and/or processing and/or camera and/or circuitry may utilize aspects described in U.S. Pat. Nos. 7,005,974; 5,760,962; 5,877,897; 5,796,094; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; 7,859,565; 5,550,677; 5,670,935; 6,636,258; 7,145,519; 7,161,616; 7,230,640; 7,248,283; 7,295,229; 7,301,466; 7,592,928; 7,881,496; 7,720,580; 7,038,577; 6,882,287; 5,929,786 and/or 5,786,772, and/or International Publication Nos. WO 2011/028686; WO 2010/099416; WO 2012/061567; WO 2012/068331; WO 2012/075250; WO 2012/103193; WO 2012/0116043; WO 2012/0145313; WO 2012/0145501; WO 2012/145818; WO 2012/145822; WO 201 2/1 581 67; WO 2012/075250; WO 2012/0116043; WO 2012/0145501; WO 2012/154919; WO 2013/019707; WO 2013/016409; WO 2013/019795; WO 2013/067083; WO 2013/070539; WO 2013/043661; WO 2013/048994; WO 2013/063014, WO 2013/081984; WO 2013/081985; WO 2013/074604; WO 2013/086249; WO 2013/103548; WO 2013/109869; WO 2013/123161; WO 2013/126715; WO 2013/043661 and/or WO 2013/158592, and/or U.S. patent applications, Ser. No. 14/359,341, filed May 20, 2014 (Attorney Docket MAG04 P-1961); Ser. No. 14/359,340, filed May 20, 2014 (Attorney Docket MAG04 P-1961); Ser. No. 14/282,029, filed May 20, 2014 (Attorney Docket MAG04 P-2287); Ser. No. 14/282,028, filed May 20, 2014 (Attorney Docket MAG04 P-2286); Ser. No. 14/358,232, filed May 15, 2014 (Attorney Docket MAG04 P-1959); Ser. No. 14/272,834, filed May 8, 2014 (Attorney Docket MAG04 P-2278); Ser. No. 14/356,330, filed May 5, 2014 (Attorney Docket MAG04 P-1954); Ser. No. 14/269,788, filed May 5, 2014 (Attorney Docket MAG04 P-2276); Ser. No. 14/268,169, filed May 2, 2014 (Attorney Docket MAG04 P-2273); Ser. No. 14/264,443, filed Apr. 29, 2014 (Attorney Docket MAG04 P-2270); Ser. No. 14/354,675, filed Apr. 28, 2014 (Attorney Docket MAG04 P-1953); Ser. No. 14/248,602, filed Apr. 9, 2014 (Attorney Docket MAG04 P-2257); Ser. No. 14/242,038, filed Apr. 1, 2014 (Attorney Docket MAG04 P-2255); Ser. No. 14/229,061, filed Mar. 28, 2014 (Attorney Docket MAG04 P-2246); Ser. No. 14/343,937, filed Mar. 10, 2014 (Attorney Docket MAG04 P-1942); Ser. No. 14/343,936, filed Mar. 10, 2014 (Attorney Docket MAG04 P-1937); Ser. No. 14/195,135, filed Mar. 3, 2014 (Attorney Docket MAG04 P-2237); Ser. No. 14/195,136, filed Mar. 3, 2014 (Attorney Docket MAG04 P-2238); Ser. No. 14/191,512, filed Feb. 27, 2014 (Attorney Docket No. MAG04 P-2228); Ser. No. 14/183,613, filed Feb. 19, 2014 (Attorney Docket No. MAG04 P-2225); Ser. No. 14/169,329, filed Jan. 31, 2014 (Attorney Docket MAG04 P-2218); Ser. No. 14/169,328, filed Jan. 31, 2014 (Attorney Docket MAG04 P-2217); Ser. No. 14/163,325, filed Jan. 24, 2014 (Attorney Docket No. MAG04 P-2216); Ser. No. 14/159,772, filed Jan. 21, 2014 (Attorney Docket MAG04 P-2215); Ser. No. 14/107,624, filed Dec. 16, 2013 (Attorney Docket MAG04 P-2206); Ser. No. 14/102,981, filed Dec. 11, 2013 (Attorney Docket MAG04 P-2196); Ser. No. 14/102,980, filed Dec. 11, 2013 (Attorney Docket MAG04 P-2195); Ser. No. 14/098,817, filed Dec. 6, 2013 (Attorney Docket MAG04 P-2193); Ser. No. 14/097,581, filed Dec. 5, 2013 (Attorney Docket MAG04 P-2192); Ser. No. 14/093,981, filed Dec. 2, 2013 (Attorney Docket MAG04 P-2197); Ser. No. 14/093,980, filed Dec. 2, 2013 (Attorney Docket MAG04 P-2191); Ser. No. 14/082,573, filed Nov. 18, 2013 (Attorney Docket MAG04 P-2183); Ser. No. 14/082,574, filed Nov. 18, 2013 (Attorney Docket MAG04 P-2184); Ser. No. 14/082,575, filed Nov. 18, 2013 (Attorney Docket MAG04 P-2185); Ser. No. 14/082,577, filed Nov. 18, 2013 (Attorney Docket MAG04 P-2203); Ser. No. 14/071,086, filed Nov. 4, 2013 (Attorney Docket MAG04 P-2208); Ser. No. 14/076,524, filed Nov. 11, 2013 (Attorney Docket MAG04 P-2209); Ser. No. 14/052,945, filed Oct. 14, 2013 (Attorney Docket MAG04 P-2165); Ser. No. 14/046,174, filed Oct. 4, 2013 (Attorney Docket MAG04 P-2158); Ser. No. 14/016,790, filed Oct. 3, 2013 (Attorney Docket MAG04 P-2139); Ser. No. 14/036,723, filed Sep. 25, 2013 (Attorney Docket MAG04 P-2148); Ser. No. 14/016,790, filed Sep. 3, 2013 (Attorney Docket MAG04 P-2139); Ser. No. 14/001,272, filed Aug. 23, 2013 (Attorney Docket MAG04 P-1824); Ser. No. 13/970,868, filed Aug. 20, 2013 (Attorney Docket MAG04 P-2131); Ser. No. 13/964,134, filed Aug. 12, 2013 (Attorney Docket MAG04 P-2123); Ser. No. 13/942,758, filed Jul. 16, 2013 (Attorney Docket MAG04 P-2127); Ser. No. 13/942,753, filed Jul. 16, 2013 (Attorney Docket MAG04 P-2112); Ser. No. 13/927,680, filed Jun. 26, 2013 (Attorney Docket MAG04 P-2091); Ser. No. 13/916,051, filed Jun. 12, 2013 (Attorney Docket MAG04 P-2081); Ser. No. 13/894,870, filed May 15, 2013 (Attorney Docket MAG04 P-2062); Ser. No. 13/887,724, filed May 6, 2013 (Attorney Docket MAG04 P-2072); Ser. No. 13/852,190, filed Mar. 28, 2013 (Attorney Docket MAG04 P-2046); Ser. No. 13/851,378, filed Mar. 27, 2013 (Attorney Docket MAG04 P-2036); Ser. No. 13/848,796, filed Mar. 22, 2012 (Attorney Docket MAG04 P-2034); Ser. No. 13/847,815, filed Mar. 20, 2013 (Attorney Docket MAG04 P-2030); Ser. No. 13/800,697, filed Mar. 13, 2013 (Attorney Docket MAG04 P-2060); Ser. No. 13/785,099, filed Mar. 5, 2013 (Attorney Docket MAG04 P-2017); Ser. No. 13/779,881, filed Feb. 28, 2013 (Attorney Docket MAG04 P-2028); Ser. No. 13/774,317, filed Feb. 22, 2013 (Attorney Docket MAG04 P-2015); Ser. No. 13/774,315, filed Feb. 22, 2013 (Attorney Docket MAG04 P-2013); Ser. No. 13/681,963, filed Nov. 20, 2012 (Attorney Docket MAG04 P-1983); Ser. No. 13/660,306, filed Oct. 25, 2012 (Attorney Docket MAG04 P-1950); Ser. No. 13/653,577, filed Oct. 17, 2012 (Attorney Docket MAG04 P-1948); and/or Ser. No. 13/534,657, filed Jun. 27, 2012 (Attorney Docket MAG04 P-1892), and/or U.S. provisional applications, Ser. No. 61/993,736, filed May 15, 2014; Ser. No. 61/991,810, filed May 12, 2014; Ser. No. 61/991,809, filed May 12, 2014; Ser. No. 61/990,927, filed May 9, 2014; Ser. No. 61/989,652, filed May 7, 2014; Ser. No. 61/981,938, filed Apr. 21, 2014; Ser. No. 61/981,937, filed Apr. 21, 2014; Ser. No. 61/977,941, filed Apr. 10, 2014; Ser. No. 61/977,940, filed Apr. 10, 2014; Ser. No. 61/977,929, filed Apr. 10, 2014; Ser. No. 61/977,928, filed Apr. 10,2014; Ser. No. 61/973,922, filed Apr. 2, 2014; Ser. No. 61/972,708, filed Mar. 31, 2014; Ser. No. 61/972,707, filed Mar. 31, 2014; Ser. No. 61/969,474, filed Mar. 24, 2014; Ser. No. 61/955,831, filed Mar. 20, 2014; Ser. No. 61/953,970, filed Mar. 17, 2014; Ser. No. 61/952,335, filed Mar. 13, 2014; Ser. No. 61/952,334, filed Mar. 13, 2014; Ser. No. 61/950,261, filed Mar. 10, 2014; Ser. No. 61/950,261, filed Mar. 10, 2014; Ser. No. 61/947,638, filed Mar. 4, 2014; Ser. No. 61/947,053, filed Mar. 3, 2014; Ser. No. 61/941,568, filed Feb. 19, 2014; Ser. No. 61/935,485, filed Feb. 4, 2014; Ser. No. 61/935,057, filed Feb. 3, 2014; Ser. No. 61/935,056, filed Feb. 3, 2014; Ser. No. 61/935,055, filed Feb. 3, 2014; Ser. 61/931,811, filed Jan. 27, 2014; Ser. No. 61/919,129, filed Dec. 20, 2013; Ser. No. 61/919,130, filed Dec. 20, 2013; Ser. No. 61/919,131, filed Dec. 20, 2013; Ser. No. 61/919,147, filed Dec. 20, 2013; Ser. No. 61/919,138, filed Dec. 20, 2013, Ser. No. 61/919,133, filed Dec. 20, 2013; Ser. No. 61/918,290, filed Dec. 19, 2013; Ser. No. 61/915,218, filed Dec. 12, 2013; Ser. No. 61/912,146, filed Dec. 5, 2013; Ser. No. 61/911, 666, filed Dec. 4, 2013; Ser. No. 61/911,665, filed Dec. 4, 2013; Ser. No. 61/905,461, filed Nov. 18, 2013; Ser. No. 61/905,462, filed Nov. 18, 2013; Ser. No. 61/901,127, filed Nov. 7, 2013; Ser. No. 61/895,610, filed Oct. 25, 2013; Ser. No. 61/895,609, filed Oct. 25, 2013; Ser. No. 61/879,837, filed Sep. 19, 2013; Ser. No. 61/879,835, filed Sep. 19, 2013; Ser. No. 61/875,351, filed Sep. 9, 2013; Ser. No. 61/869,195, filed. Aug. 23, 2013; Ser. No. 61/864,835, filed Aug. 12, 2013; Ser. No. 61/864,836, filed Aug. 12, 2013; Ser. No. 61/864,837, filed Aug. 12, 2013; Ser. No. 61/864,838, filed Aug. 12, 2013; Ser. No. 61/856,843, filed Jul. 22, 2013, Ser. No. 61/845,061, filed Jul. 11, 2013; Ser. No. 61/844,630, filed Jul. 10, 2013; Ser. No. 61/844,173, filed Jul. 9, 2013; Ser. No. 61/844,171, filed Jul. 9, 2013; Ser. No. 61/842,644, filed Jul. 3, 2013; Ser. No. 61/840,542, filed Jun. 28, 2013; Ser. No. 61/838,619, filed Jun. 24, 2013; Ser. No. 61/838,621, filed Jun. 24, 2013; Ser. No. 61/837,955, filed Jun. 21, 2013; Ser. No. 61/836,900, filed Jun. 19, 2013; Ser. No. 61/836,380, filed Jun. 18, 2013; Ser. No. 61/833,080, filed Jun. 10, 2013; Ser. No. 61/830,375, filed Jun. 3, 2013; and/or Ser. No. 61/830,377, filed Jun. 3, 2013; which are all hereby incorporated herein by reference in their entireties. The system may communicate with other communication systems via any suitable means, such as by utilizing aspects of the systems described in International Publication Nos. WO/2010/144900; WO 2013/043661 and/or WO 2013/081985, and/or U.S. patent application Ser. No. 13/202,005, filed Aug. 17, 2011 (Attorney Docket MAG04 P-1595), which are hereby incorporated herein by reference in their entireties.

The imaging device and control and image processor and any associated illumination source, if applicable, may comprise any suitable components, and may utilize aspects of the cameras and vision systems described in U.S. Pat. Nos. 5,550,677; 5,877,897; 6,498,620; 5,670,935; 5,796,094; 6,396,397; 6,806,452; 6,690,268; 7,005,974; 7,937,667; 7,123,168; 7,004,606; 6,946,978; 7,038,577; 6,353,392; 6,320,176; 6,313,454; and/or 6,824,281, and/or International Publication Nos. WO 2010/099416; WO 2011/028686; and/or WO 2013/016409, and/or U.S. Pat. Publication No. US 2010-0020170, and/or U.S. patent application Ser. No. 13/534,657, filed Jun. 27, 2012 (Attorney Docket MAG04 P-1892), which are all hereby incorporated herein by reference in their entireties. The camera or cameras may comprise any suitable cameras or imaging sensors or camera modules, and may utilize aspects of the cameras or sensors described in U.S. Publication No. US-2009-0244361 and/or U.S. patent application Ser. No. 13/260,400, filed Sep. 26, 2011 (Attorney Docket MAG04 P-1757), and/or U.S. Pat. Nos. 7,965,336 and/or 7,480,149, which are hereby incorporated herein by reference in their entireties. The imaging array sensor may comprise any suitable sensor, and may utilize various imaging sensors or imaging array sensors or cameras or the like, such as a CMOS imaging array sensor, a CCD sensor or other sensors or the like, such as the types described in U.S. Pat. Nos. 5,550,677; 5,670,935; 5,760,962; 5,715,093; 5,877,897; 6,922,292; 6,757,109; 6,717,610; 6,590,719; 6,201,642; 6,498,620; 5,796,094; 6,097,023; 6,320,176; 6,559,435; 6,831,261; 6,806,452; 6,396,397; 6,822,563; 6,946,978; 7,339,149; 7,038,577; 7,004,606; 7,720,580; and/or 7,965,336, and/or International Publication Nos. WO/2009/036176 and/or WO/2009/046268, which are all hereby incorporated herein by reference in their entireties.

The camera module and circuit chip or board and imaging sensor may be implemented and operated in connection with various vehicular vision-based systems, and/or may be operable utilizing the principles of such other vehicular systems, such as a vehicle headlamp control system, such as the type disclosed in U.S. Pat. Nos. 5,796,094; 6,097,023; 6,320,176; 6,559,435; 6,831,261; 7,004,606; 7,339,149; and/or 7,526,103, which are all hereby incorporated herein by reference in their entireties, a rain sensor, such as the types disclosed in commonly assigned U.S. Pat. Nos. 6,353,392; 6,313,454; 6,320,176; and/or 7,480,149, which are hereby incorporated herein by reference in their entireties, a vehicle vision system, such as a forwardly, sidewardly or rearwardly directed vehicle vision system utilizing principles disclosed in U.S. Pat. Nos. 5,550,677; 5,670,935; 5,760,962; 5,877,897; 5,949,331; 6,222,447; 6,302,545; 6,396,397; 6,498,620; 6,523,964; 6,611,202; 6,201,642; 6,690,268; 6,717,610; 6,757,109; 6,802,617; 6,806,452; 6,822,563; 6,891,563; 6,946,978; and/or 7,859,565, which are all hereby incorporated herein by reference in their entireties, a trailer hitching aid or tow check system, such as the type disclosed in U.S. Pat. No. 7,005,974, which is hereby incorporated herein by reference in its entirety, a reverse or sideward imaging system, such as for a lane change assistance system or lane departure warning system or for a blind spot or object detection system, such as imaging or detection systems of the types disclosed in U.S. Pat. Nos. 7,881,496; 7,720,580; 7,038,577; 5,929,786 and/or 5,786,772, and/or U.S. provisional applications, Ser. No. 60/628,709, filed Nov. 17, 2004; Ser. No. 60/614,644, filed Sep. 30, 2004; Ser. No. 60/618,686, filed Oct. 14, 2004; Ser. No. 60/638,687, filed Dec. 23, 2004, which are hereby incorporated herein by reference in their entireties, a video device for internal cabin surveillance and/or video telephone function, such as disclosed in U.S. Pat. Nos. 5,760,962; 5,877,897; 6,690,268; and/or 7,370,983, and/or U.S. Publication No. US-2006-0050018, which are hereby incorporated herein by reference in their entireties, a traffic sign recognition system, a system for determining a distance to a leading or trailing vehicle or object, such as a system utilizing the principles disclosed in U.S. Pat. Nos. 6,396,397 and/or 7,123,168, which are hereby incorporated herein by reference in their entireties, and/or the like.

Optionally, the circuit board or chip may include circuitry for the imaging array sensor and or other electronic accessories or features, such as by utilizing compass-on-a-chip or EC driver-on-a-chip technology and aspects such as described in U.S. Pat. No. 7,255,451 and/or U.S. Pat. No. 7,480,149; and/or U.S. Publication No. US-2006-0061008 and/or U.S. patent application Ser. No. 12/578,732, filed Oct. 14, 2009 (Attorney Docket DON01 P-1564), which are hereby incorporated herein by reference in their entireties.

Optionally, the vision system may include a display for displaying images captured by one or more of the imaging sensors for viewing by the driver of the vehicle while the driver is normally operating the vehicle. Optionally, for example, the vision system may include a video display device disposed at or in the interior rearview mirror assembly of the vehicle, such as by utilizing aspects of the video mirror display systems described in U.S. Pat. No. 6,690,268 and/or U.S. patent application Ser. No. 13/333,337, filed Dec. 21, 2011 (Attorney Docket DON01 P-1797), which are hereby incorporated herein by reference in their entireties. The video mirror display may comprise any suitable devices and systems and optionally may utilize aspects of the compass display systems described in U.S. Pat. Nos. 7,370,983; 7,329,013; 7,308,341; 7,289,037; 7,249,860; 7,004,593; 4,546,551; 5,699,044; 4,953,305; 5,576,687; 5,632,092; 5,677,851; 5,708,410; 5,737,226; 5,802,727; 5,878,370; 6,087,953; 6,173,508; 6,222,460; 6,513,252; and/or 6,642,851, and/or European patent application, published Oct. 11, 2000 under Publication No. EP 0 1043566, and/or U.S. Publication No. US-2006-0061008, which are all hereby incorporated herein by reference in their entireties. Optionally, the video mirror display screen or device may be operable to display images captured by a rearward viewing camera of the vehicle during a reversing maneuver of the vehicle (such as responsive to the vehicle gear actuator being placed in a reverse gear position or the like) to assist the driver in backing up the vehicle, and optionally may be operable to display the compass heading or directional heading character or icon when the vehicle is not undertaking a reversing maneuver, such as when the vehicle is being driven in a forward direction along a road (such as by utilizing aspects of the display system described in International Publication No. WO 2012/051500, which is hereby incorporated herein by reference in its entirety).

Optionally, the vision system (utilizing the forward facing camera and a rearward facing camera and other cameras disposed at the vehicle with exterior fields of view) may be part of or may provide a display of a top-down view or birds-eye view system of the vehicle or a surround view at the vehicle, such as by utilizing aspects of the vision systems described in International Publication Nos. WO 2010/099416; WO 2011/028686; WO 2012/075250; WO 2013/019795; WO 2012/075250; WO 2012/145822; WO 2013/081985; WO 2013/086249; and/or WO 2013/109869, and/or U.S. patent application Ser. No. 13/333,337, filed Dec. 21, 2011 (Attorney Docket DON01 P-1797), which are hereby incorporated herein by reference in their entireties.

Optionally, a video mirror display may be disposed rearward of and behind the reflective element assembly and may comprise a display such as the types disclosed in U.S. Pat. Nos. 5,530,240; 6,329,925; 7,855,755; 7,626,749; 7,581,859; 7,446,650; 7,370,983; 7,338,177; 7,274,501; 7,255,451; 7,195,381; 7,184,190; 5,668,663; 5,724,187 and/or 6,690,268, and/or in U.S. Publication Nos. US-2006-0061008 and/or US-2006-0050018, which are all hereby incorporated herein by reference in their entireties. The display is viewable through the reflective element when the display is activated to display information. The display element may be any type of display element, such as a vacuum fluorescent (VF) display element, a light emitting diode (LED) display element, such as an organic light emitting diode (OLED) or an inorganic light emitting diode, an electroluminescent (EL) display element, a liquid crystal display (LCD) element, a video screen display element or backlit thin film transistor (TFT) display element or the like, and may be operable to display various information (as discrete characters, icons or the like, or in a multi-pixel manner) to the driver of the vehicle, such as passenger side inflatable restraint (PSIR) information, tire pressure status, and/or the like. The mirror assembly and/or display may utilize aspects described in U.S. Pat. Nos. 7,184,190; 7,255,451; 7,446,924 and/or 7,338,177, which are all hereby incorporated herein by reference in their entireties. The thicknesses and materials of the coatings on the substrates of the reflective element may be selected to provide a desired color or tint to the mirror reflective element, such as a blue colored reflector, such as is known in the art and such as described in U.S. Pat. Nos. 5,910,854; 6,420,036; and/or 7,274,501, which are hereby incorporated herein by reference in their entireties.

Optionally, the display or displays and any associated user inputs may be associated with various accessories or systems, such as, for example, a tire pressure monitoring system or a passenger air bag status or a garage door opening system or a telematics system or any other accessory or system of the mirror assembly or of the vehicle or of an accessory module or console of the vehicle, such as an accessory module or console of the types described in U.S. Pat. Nos. 7,289,037; 6,877,888; 6,824,281; 6,690,268; 6,672,744; 6,386,742; and 6,124,886, and/or U.S. Publication No. US-2006-0050018, which are hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vision system of a vehicle, said vision system comprising:
a camera disposed at a vehicle and having a field of view exterior of the vehicle;
wherein said camera comprises a lens and a two dimensional pixelated imaging array having a plurality of photosensing elements arranged in rows and columns of photosensing elements;
wherein said camera is operable to sense color via color filtering at photosensing elements of said pixelated imaging array;
an image processor operable to process image data captured by said camera;
wherein said vision system is operable to determine color aberration in the captured images;
wherein said vision system determines color aberration based at least in part on parameters of portions of said lens that correlate to respective pixel portions of said imaging array; and
wherein, responsive at least in part to processing of image data by said image processor, said vision system at least in part corrects the color aberration via correlation of respective pixels of said imaging array to parameters of respective portions of said lens focusing light at those pixels.

2. The vision system of claim 1, wherein said image processor at least in part corrects the color aberration by scaling color channels according to a location of a respective pixel and a respective parameter of said lens at that location.

3. The vision system of claim 2, wherein said color channels comprise at least a red color channel, a green color channel and a blue color channel.

4. The vision system of claim 2, wherein said vision system at least in part corrects the color aberration by scaling color channels of said camera as a function of a distance of a respective pixel from a center of said imaging array.

5. The vision system of claim 1, wherein said vision system determines a displacement distance of the color components of the images.

6. The vision system of claim 5, wherein the displacement distance is determined responsive to the parameters of said lens.

7. The vision system of claim 6, wherein said vision system adjusts captured image data in accordance with the determined displacement distance to correct the aberration of colors.

8. The vision system of claim 1, wherein said vision system determines color aberration based at least in part on distances of pixels of said imaging array from a center pixel that corresponds with a central axis of said lens.

9. The vision system of claim 8, wherein said parameters of said lens include at least a curvature of said lens.

10. The vision system of claim 1, wherein said lens comprises a single lens optic that focuses light at pixels of said imaging array.

11. The vision system of claim 1, wherein said image processor at least in part corrects the color aberration transversal/lateral chromatic aberration.

12. The vision system of claim 1, wherein said camera comprises a backup camera disposed at a rear portion of the vehicle and having a field of view rearward of the vehicle.

13. The vision system of claim 1, wherein said camera is part of a multi-camera surround vision system of the vehicle having a plurality of cameras, each having a lens and respective exterior field of view.

14. A vision system of a vehicle, said vision system comprising:
a camera disposed at a rear portion of a vehicle and having a field of view exterior and rearward of the vehicle;
wherein said camera comprises a lens and a two dimensional pixelated imaging array having a plurality of photosensing elements arranged in rows and columns of photosensing elements;
wherein said lens comprises a single lens optic that focuses light at pixels of said imaging array;
wherein said camera is operable to sense color via color filtering at photosensing elements of said pixelated imaging array;
an image processor operable to process image data captured by said camera;
wherein, responsive to image processing of captured image data, said image processor is operable to determine objects present in the field of view of said camera;
wherein said vision system is operable to determine color aberration in the captured images;
wherein said vision system determines color aberration based at least in part on parameters of portions of said lens that correlate to respective pixel portions of said imaging array; and
wherein, responsive at least in part to processing of image data by said image processor, said vision system at least in part corrects the color aberration via correlation of respective pixels of said imaging array to parameters of respective portions of said lens focusing light at those pixels.

15. The vision system of claim 14, wherein said image processor at least in part corrects the color aberration by scaling color channels according to a location of a respective pixel and a respective parameter of said lens at that location.

16. The vision system of claim 14, wherein said vision system determines a displacement distance of the color components of the images, and wherein the displacement distance is determined responsive to the parameters of said lens, and wherein said vision system adjusts captured image data in accordance with the determined displacement distance to correct the aberration of colors.

17. The vision system of claim 14, wherein said vision system determines color aberration based at least in part on distances of pixels of said imaging array from a center pixel that corresponds with a central axis of said lens.

18. The vision system of claim 14, wherein said parameters of said lens include at least a curvature of said lens.

19. A vision system of a vehicle, said vision system comprising:
a plurality of cameras disposed at a vehicle, each having a respective field of view exterior of the vehicle;
wherein each of said cameras comprises a lens and a two dimensional pixelated imaging array having a plurality of photosensing elements arranged in rows and columns of photosensing elements;
wherein said cameras are operable to sense color via color filtering at photosensing elements of said pixelated imaging arrays;
an image processor operable to process image data captured by said cameras;
wherein said vision system is operable to determine color aberration in the captured images;
wherein said vision system determines color aberration based at least in part on parameters of portions of said lenses that correlate to respective pixel portions of the imaging arrays of the respective camera;
wherein, responsive at least in part to processing of image data by said image processor, said vision system at least in part corrects the color aberration via correlation of respective pixels of said imaging arrays to parameters of respective portions of the lens focusing light at those pixels; and
wherein said vision system determines color aberration based at least in part on distances of pixels of said imaging array from a center pixel that corresponds with a central axis of said lens.

20. The vision system of claim 19, wherein said image processor at least in part corrects the color aberration by scaling color channels according to a location of a respective pixel and a respective parameter of said lens at that location, and wherein said vision system at least in part corrects the color aberration by scaling color channels of said camera as a function of a distance of a respective pixel from a center of said imaging array.
